(19) United States
(12) Patent Application Publication
(10) Pub. No.: US 2026/0217462 A1
(43) Pub. Date: Jul. 30, 2026

(54) SYSTEMS AND METHODS FOR TRANSFERRING CONTAINERS TO A STORAGE STRUCTURE

(71) Applicant: Symbotic LLC, Wilmington, MA (US)

(72) Inventors: Alan J. Grant, Nashua, NH (US); Julian D. Warhurst, Portsmouth, RI (US)

(21) Appl. No.: 19/041,529

(22) Filed: Jan. 30, 2025

(51) Int. Cl. B65G 1/137; B65G 1/127; B65G 11/02

(52) U.S. Cl. CPC B65G 1/1373; B65G 1/127; B65G 11/02

(57) ABSTRACT

In some embodiments, apparatuses and methods are provided herein useful to transfer containers to a storage structure in an automated storage and retrieval system. A system for transferring containers to a storage structure includes a workstation cooperated with a storage structure. A chute has an originating end in the storage structure and a terminal end at the workstation. The chute receives containers provided by mobile robots in the storage structure and the containers travel down the chute to the workstation. An elevator at the workstation transports containers from the workstation to the storage structure. The elevator includes an automatic door to open when the carriage arrives at the workstation and to close after the container is received by the carriage. The elevator includes an ejector to eject the container from the carriage to a mobile robot in the storage structure.

### TECHNICAL FIELD

This disclosure relates generally to automated storage and retrieval systems, and more particularly, to transferring containers to a storage structure in an automated storage and retrieval system.

### BACKGROUND

Automated storage and retrieval systems are often used by large retail entities to manage inventory. Typical automated storage and retrieval systems are generally configured to store products in a multilevel storage structure at a fulfillment facility. For example, products received at a fulfillment facility may be loaded (i.e., decanted) into containers at a workstation and transferred from the workstation to locations in the storage structure using mobile robots. There is a need to improve efficiency and reduce downtime associated with decanting products for storage using automated systems.

### BRIEF DESCRIPTION OF DRAWINGS

Disclosed herein are embodiments of systems, apparatuses and methods pertaining to transferring containers to a storage structure, for example, in an automated storage and retrieval system. This description includes drawings, wherein:

FIG. 1 illustrates part of an order fulfillment facility, in accordance with some embodiments.

FIG. 2 illustrates part of an order fulfillment facility, in accordance with some embodiments.

FIG. 3 illustrates a storage structure in an order fulfillment facility, in accordance with some embodiments.

FIG. 4 is a simplified block diagram of a system for transferring containers to a storage structure, in accordance with some embodiments.

FIG. 5A illustrates a system for transferring containers to a storage structure, in accordance with some embodiments.

FIG. 5B illustrates a system for transferring containers to a storage structure, in accordance with some embodiments.

FIG. 6 illustrates a system for transferring containers to a storage structure, in accordance with some embodiments.

FIG. 7 illustrates a chute, in accordance with some embodiments.

FIG. 8 illustrates an elevator, in accordance with some embodiments.

FIG. 9 illustrates an elevator carriage, in accordance with some embodiments.

FIG. 10 illustrates an elevator carriage, in accordance with some embodiments.

FIG. 11 illustrates an elevator carriage, in accordance with some embodiments.

FIG. 12 illustrates a container, in accordance with several embodiments.

FIG. 13 illustrates a mobile robot, in accordance with several embodiments.

FIG. 14 illustrates a method of transferring containers to a storage structure, in accordance with some embodiments.

FIG. 15 illustrates a method of transferring containers to a storage structure, in accordance with some embodiments.

FIG. 16 illustrates a system for use in implementing methods, techniques, devices, apparatuses, systems, servers, processors, microprocessors, processing systems, and sources for transferring containers to a storage structure, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to transfer containers to a storage structure, for example, in an automated storage and retrieval system. The term “decanting” refers to the process by which cases of products are received at a workstation from a supplier, vendor, etc. and individual products are removed from the cases and placed into containers for storage in an automated storage and retrieval system. In conventional decanting systems and processes, containers (which may contain items or products) may be transferred to mobile robots at a workstation, and the mobile robots may transport the containers from the workstation to storage locations. Similarly, mobile robots may transfer empty or partially full containers to the workstation. The systems, apparatuses, and methods described herein utilize a unique combination modular elements to quickly and efficiently decant products into containers and transfer the containers to storage locations. Advantageously, the systems, apparatuses, and methods described herein may improve efficiency, reduce downtime, and increase worker safety. While the systems, apparatuses and methods described herein may be particularly useful with automated storage and retrieval systems, they are not limited to use with such systems.

In one aspect, and without limitation, this disclosure may involve generally a facility, such as an order fulfillment facility, which may include multiple mobile robots that operate to transfer containers in the context of an automated storage and retrieval system. In one form, mobile robots move about a storage structure and transport containers of goods (which may also be referred to as “totes”) to and from specific storage locations in the storage structure. The order fulfillment facility may include container processing stations such as picking stations, where items are removed from containers to fulfill orders. The fulfillment facility may also include workstations (e.g., decanting stations) where containers may be loaded with products and transferred to the storage structure. One or more chutes and one or more elevators may be coupled to the storage structure and the workstation. The chutes may be configured to supply containers to the workstation and the elevators may be configured to transport the containers to a level of the storage structure. The containers may then be transferred to a mobile robot, which transports the containers to their storage locations in the storage structure.

Advantageously, the embodiments, systems, apparatuses and methods provided herein utilize modular elements to improve efficiency and reduce downtime. Additionally, the chute(s) and elevator(s) provide a buffer between workers at the workstation and the mobile robots, thereby preventing intentional or accidental interaction with the mobile robots.

In some embodiments, a system for transferring containers to a storage structure may include a workstation cooperated with the storage structure. In some aspects, the workstation may comprise a sensor for sensing at least one attribute of the container. The storage structure may include multiple vertically spaced levels each having multiple storage locations. The vertically spaced levels may be configured to allow a mobile robot to traverse the storage structure. A chute may extend vertically along the storage structure, the chute having an originating end disposed at a level of the storage structure and a terminal end disposed at the workstation. The chute receives containers provided by mobile robots through an upper opening at the originating end of the chute and guides the containers to a lower opening at the terminal end of the chute. The chute may hold multiple containers stacked at the terminal end.

The system may further include an elevator to vertically transport containers via a carriage from the workstation to levels of the storage structure and to return the carriage to the workstation. The elevator may include the carriage for receiving a container, an automatic door to open when the carriage arrives at the workstation and to close after the container is received by the carriage, and an ejector to eject the container from the carriage to a mobile robot once the carriage has arrived at a particular level of the storage structure. In some aspects, the workstation may be inaccessible by the mobile robot from the storage structure. In some aspects, the system may include a plurality of the chutes and a plurality of elevators, and the plurality of the chutes function separately from one another and the plurality of the elevators function separately from one another.

A reader may be associated with the elevator to read machine-readable codes or “identifiers” affixed to containers. The system may further include a computer-readable storage memory storing a storage database mapping containers to storage locations, and a set of computer executable instructions, and a control circuit communicatively coupled to the workstation, elevator, and mobile robots, the control circuit to execute the set of computer executable instructions, which causes the control circuit to receive from the reader an identification of the container in the carriage, query the storage database to determine an open storage location in the storage structure, assign the container to the open storage location, cause the elevator to transport the carriage with the container to the particular level associated with the open storage location, send signal to the mobile robot to retrieve the container from the elevator at the particular level associated with the open storage location, and cause the elevator to return the carriage to the workstation. The control circuit may be further coupled to the mobile robots and may send a signal to a mobile robot to deliver empty or partially full containers to the upper opening of the chute.

The chute may be passive or active. For example, in some aspects, when the containers delivered to the chute by the mobile robot are empty, the chute may be passive such that the empty containers travel down the chute without mechanical assistance. In some aspects, the chute may comprise an elongated portion connecting the originating end and the terminal end. The originating end may be disposed at an angle of about 90 degrees from the elongated portion in a first direction, and the terminal end may be disposed at an angle of about 90 degrees from the elongated portion in a second direction opposite the first direction. In some aspects, a height of the originating end of the chute and a height of the terminal end of the chute may be larger than a height of the container such that the container can enter the originating end via the upper opening in an upright configuration and exit the terminal end via the lower opening in the upright first configuration. In some aspects, an interface of the originating end and the elongated portion forms a first elbow in which the container is rotated from the upright configuration to a second configuration where a side of the container is facing downward in the direction of travel, and an interface of the elongated portion and the terminal end forms a second elbow in which the container is rotated from the second configuration back to the upright configuration.

In another form, there is provided a method for transferring containers to a storage structure. The method may include receiving, at a workstation, a container from a terminal end of a chute, wherein the chute extends vertically along a storage structure. The storage structure may comprise multiple vertically spaced levels that each comprise multiple aisles having storage locations, and the chute may have an originating end disposed at a level of the storage structure and the terminal end disposed at the workstation. The chute may receive containers provided by mobile robots through an upper opening at the originating end of the chute and may guide the containers to a lower opening at the terminal end of the chute. The chute may hold multiple containers stacked at the terminal end. The method may further include opening, caused by a control circuit to execute a set of computer executable instructions, an automatic door of an elevator when a signal is received indicating that a carriage of the elevator is at the workstation. The elevator is configured to vertically transport containers via the carriage from the workstation to levels of a storage structure and to return the carriage to the workstation. The method may further include receiving the container into the carriage of the elevator, and closing, caused by the control circuit, the automatic door of the elevator when a signal is received indicating that the container has been received by the carriage. The method may further include ejecting, by an ejector associated with the elevator, the container from the carriage to a mobile robot once the carriage has arrived at a particular level of the storage structure.

In some implementations, the method may further include receiving, by the control circuit, an identification of the container in the carriage from a reader associated with the elevator, querying, by the control circuit, a storage database mapping containers to storage locations to determine an open storage location in the storage structure, assigning, by the control circuit, the container to the open storage location, transporting, by the elevator, the carriage with the container to the particular level associated with the open storage location, sending, by the control circuit, a signal to the mobile robot to retrieve the container from the elevator at the particular level associated with the open storage location, returning, by the elevator, the carriage to the workstation. In some aspects, the method may further include, by the control circuit, sending a signal to a mobile robot to deliver empty or partially full containers to the upper opening of the chute. In some aspects, the method may further include, by a sensor associated with the workstation, sensing at least one attribute of the container.

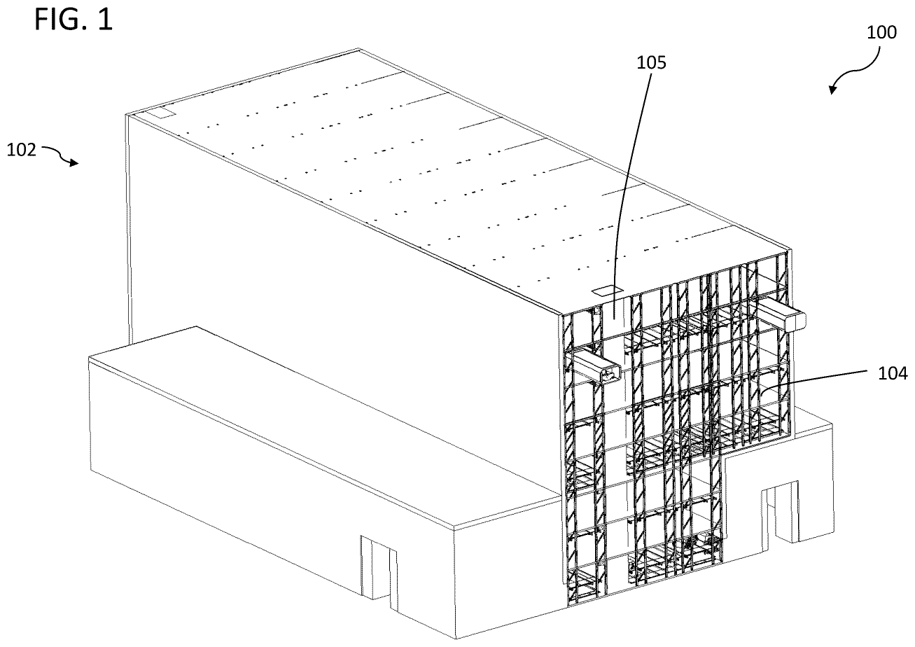

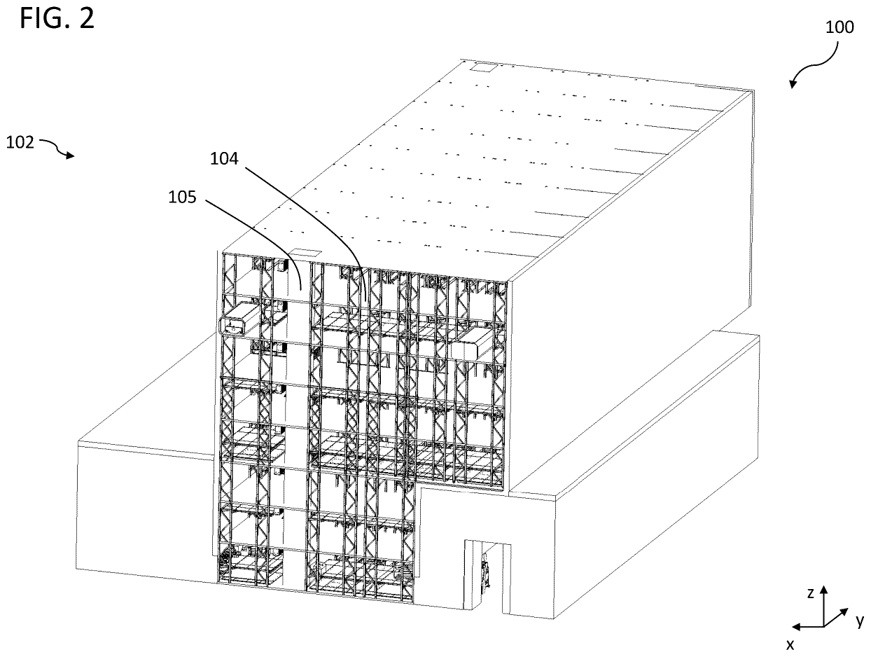

FIGS. 1-3 show parts of an order fulfillment facility 100 (or storage facility) that utilizes an automated storage and retrieval system (ASRS) in accordance with some embodiments. More specifically, as part of the ASRS, FIGS. 1 and 2 show a storage structure 102 that is generally intended to store various items or products at a number of storage locations 104. In one form, the storage structure 102 may include a y-z array of storage locations 104 in horizontal rows and climbing channels 105 (which also may be referred to as vertical towers or level changing towers) along the rows. In some forms, mobile robots may travel between storage levels in the z-direction within the climbing channels 105. Rows of storage locations 104 may be arranged to face each other, separated by horizontal pathways or aisles 106.

The storage structure 102 may further include decks 108 (which may also be referred to as transit planes or areas) spaced apart at different horizontal levels of the storage structure 102. The decks 108 may extend between the aisles 106 so that mobile robots can maneuver in the x-y plane of each deck 108 to travel between different aisles 106. Further details relating to the general structure and operation of embodiments of storage structures and mobile robots, such as may be used in conjunction with this disclosure, are disclosed in U.S. Pat. No. 9,139,363, issued Sep. 22, 2015, entitled “Automated System for Transporting Payloads”; U.S. Pat. No. 10,040,632, issued Aug. 7, 2018, entitled” Automated System for Transporting Payloads”; U.S. Pat. No. 10,435,241, issued Oct. 8, 2019, entitled “Storage and Retrieval System”; U.S. Pat. No. 10,952,533, issued Mar. 23, 2021, entitled “Modular Structure for an Automated Storage and Retrieval System”; U.S. Pat. No. 11,142,398, issued Oct. 12, 2021, entitled “Order Fulfillment System”; and International Application No. PCT/US 2025/010714, filed on Jan. 8, 2025, entitled “In-Rack Transit Plane Automatic Storage and Retrieval Systems and Methods”, which patents are all incorporated by reference herein in their entirety.

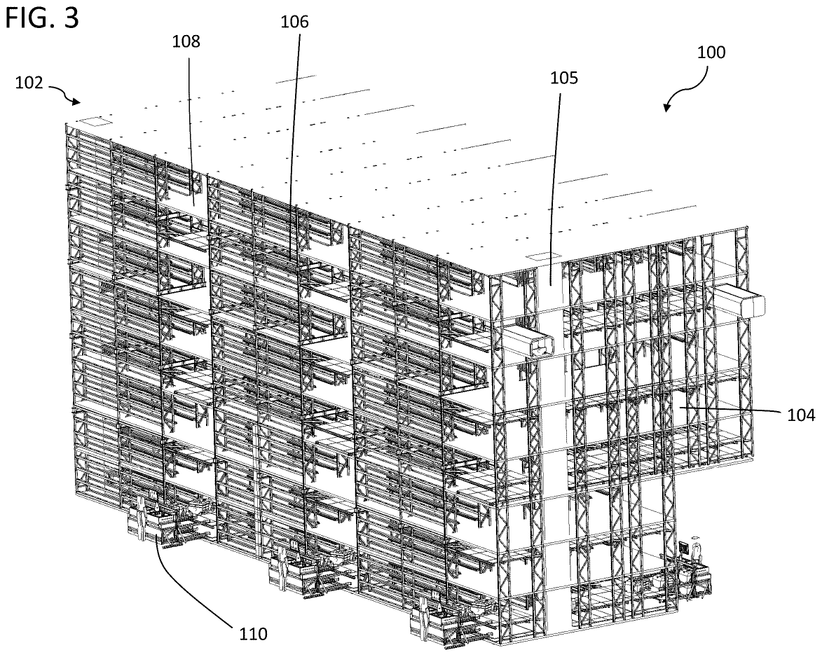

FIG. 3 further shows container processing stations 110 at the order fulfillment facility 100. In one form, operators (human individuals and/or robotic operators) work at the container processing stations 110 to fulfill or “pick” orders. Examples of container processing stations 110 for fulfilling orders, such as may be used in conjunction with this disclosure, are disclosed, for example, in U.S. Pat. No. 11,845,610, issued Dec. 19, 2023, entitled “Automated Decant System”; U.S. Patent Publication No. 2021/0380343, published Dec. 9, 2021, entitled “Robotic Each Picking in a Micro-Fulfillment Center”; and U.S. Pat. No. 10,984,375, issued Apr. 20, 2021, entitled “Picking Workstation with Mobile robots and Machine Vision Verification of Each Transfers Performed by Human Operators,” all of which are incorporated by reference herein in their entirety. In some aspects, the container processing stations 110 described above with reference to FIG. 3 may be separate from the system 103 for transferring containers described herein. In other aspects, the container processing stations 110 may be used in conjunction with the system 103 for transferring containers described herein.

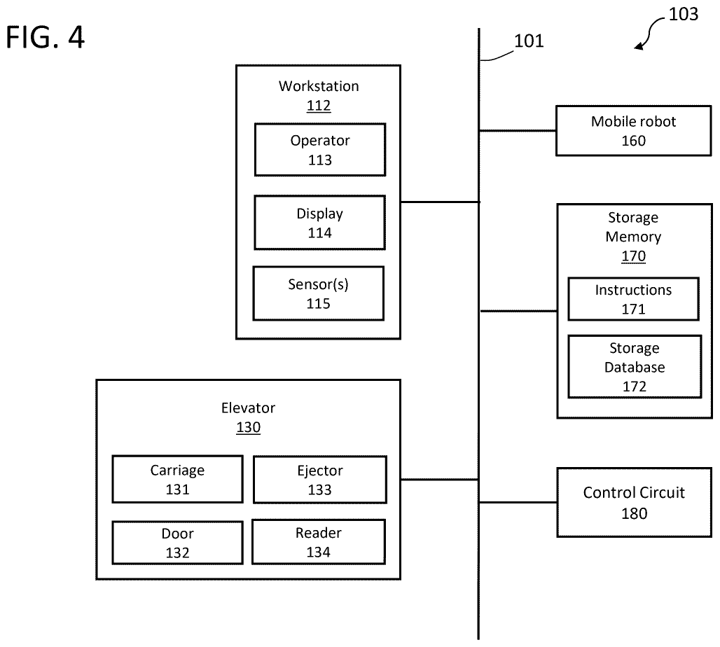

FIGS. 4-7 show a system 103 for transferring containers to a storage structure. The storage structure may be storage structure 102 in fulfillment facility 100 described above with reference to FIGS. 1-3. The storage structure 102 generally has multiple vertically spaced levels that each have multiple storage locations 104. Mobile robots 160 are configured to traverse the storage structure 102 carrying containers 150. At least one workstation 112 is cooperated with the storage structure 102, and one or more chutes 120 and one or more elevators 130 connect the workstation 112 to the storage structure 102.

The system 103 further can further include a control circuit 180 that is communicatively coupled to the workstation 112, elevator 130, and/or mobile robot 160 and components thereof via one or more wireless and/or wired distributed communication networks 101 (e.g., wireless local area network (LAN), wired LAN, wide area network (WAN), cellular network, Wi-Fi, Bluetooth, Ethernet, other such communication network, or a combination of two or more of such networks). The control circuit 180 may include a processor, a microprocessor, a central processing unit (CPU), a graphics processing unit (GPU), an application-specific integrated circuit (ASIC), and the like and may be configured to execute computer-executable instructions 171 stored on a computer-readable storage memory 170. The storage memory 170 may include volatile and/or non-volatile memory and have stored upon it, a set of computer-executable instructions 171 which, when executed by the control circuit 180, causes the control circuit 180 to perform one or more functions described herein. The storage memory 170 may store one or more databases, which may be queried by the control circuit 180. In some aspects, the storage memory 170 may store a storage database 172 mapping containers 150 to storage locations 104 in the storage structure 102.

The workstation 112 is configured to load products into containers or “totes” 150 by an operator 113. In some aspects, the operator 113 may be a human operator. In other aspects, the operator 113 may include a movable robotic arm operatively coupled to the workstation 112. In some aspects, each workstation 112 may include multiple stations for multiple operators 113 to work simultaneously. In other aspects, the workstation 112 may be configured for a single operator 113. In some aspects, the workstation 112 may include components for adjusting the height of the workstation 112 to improve safety and ergonomics for the operator 113. The system 103 may include multiple workstations 112 positioned at suitable locations about the storage structure 102.

The workstation 112 may further include a display 114, which may be a stand-alone display or a computing device with a display (e.g., a laptop, tablet, or the like). The display 114 may provide useful information and/or illustrations about products, containers 150, system health, and the like. In some embodiments, the display 114 may provide instructions and/or illustrations to the operator 113 regarding how to load or otherwise configure products in the containers 150. In some aspects, when a workstation 112 includes multiple stations for multiple operators 113 to work simultaneously, each station may include a display 114.

The workstation 112 may further include one or more sensors 115 configured to capture at least one attribute of the container 150. Suitable sensors 115 include, but are not limited to, optical sensors, imaging sensors, radio frequency identification (RFID) sensors/readers, temperature sensors, infrared sensors, humidity sensors, sound sensors, weight sensors, and/or proximity sensors. In some aspects, when a workstation 112 includes multiple stations for multiple operators 113 to work simultaneously, each station may include one or more sensors 115. The sensor 115 may be configured to alert the operator when a predetermined limit of a parameter is exceeded. For example, the elevator 130 may have a weight limit, and a sensor 115 associated with the workstation 112 may alert the operator 113 if the container 150 exceeds the elevator's weight limit.

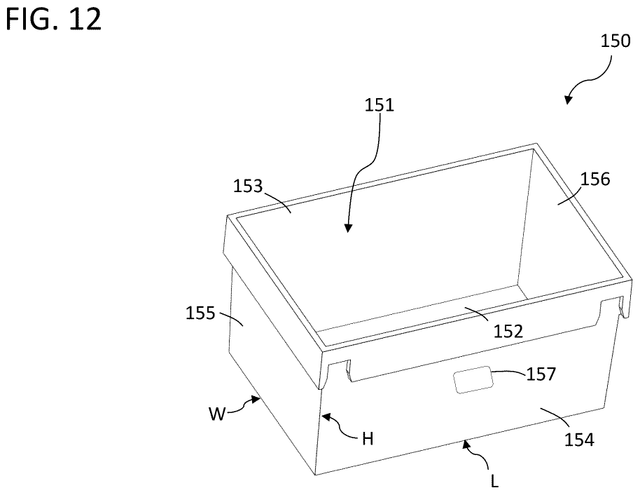

FIG. 12 illustrates an elevated perspective view of an example container 150, in accordance with some embodiments. The container 150 in some embodiments may be a generally rectangular container having a generally rectangular compartment 151 or interior and an open top to access the compartment 151. For instance, the container 150 may have a rectangular base or bottom 152 and four side walls 153, 154, 155, 156 extending upwardly therefrom. The side walls can include a first end-side 155, a second end-side 156, a first lateral side 153, and a second lateral side 154, and, together with the bottom 152, define the rectangular compartment 151. The side ends 155 and 156 may define the length (L) of the container 150 and lateral sides 153 and 154 may define the width (W) of the container 150. The sides 153, 154, 155, and 156 may be of the same height and may define the height (H) of the container. The sides 153, 154, 155, and 156 may be generally perpendicular to the bottom 152 or may, in certain approaches, be slightly angled or tapered radially outwardly from bottom to top so that the compartment 151 has a gradually increasing cross-sectional area from bottom to top. The latter configuration, in some approaches, permits the container 150 to be nestable or with other identical containers 150 (e.g., in storage, in the chute 120, etc.). The containers 150, however, may be implemented in other relevant shapes, such as but not limited to cubic, octagonal, and/or other such shapes. In some embodiments, the interior compartment 151 of the container 150 may be separated into multiple compartments or sections for receiving and positioning sub-containers.

In some approaches, the container 150 may have a machine-readable code 157 affixed thereto, which encodes information about the container 150, such as an identification. The machine-readable code 157 may be any code capable of being read by one of the sensors or readers described herein. For example, the machine-readable code 157 may be a barcode, QR code, a symbol, or the like. In another example, the machine-readable code 157 be may encoded by a radio frequency identification (RFID) tag. The machine-readable code 157 may be affixed to any suitable location of the container 150 where it may be read by sensors or readers associated with the workstation 112, elevator 130, and/or mobile robots 160.

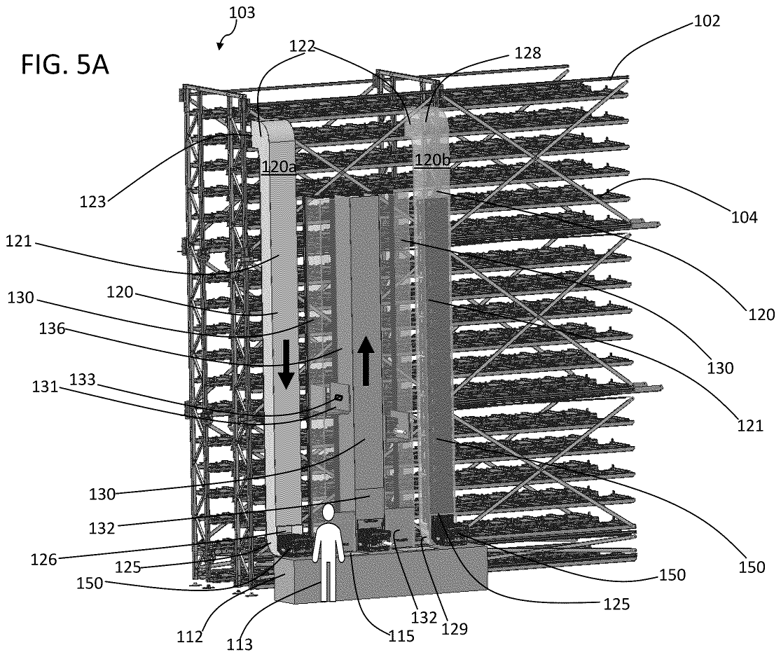

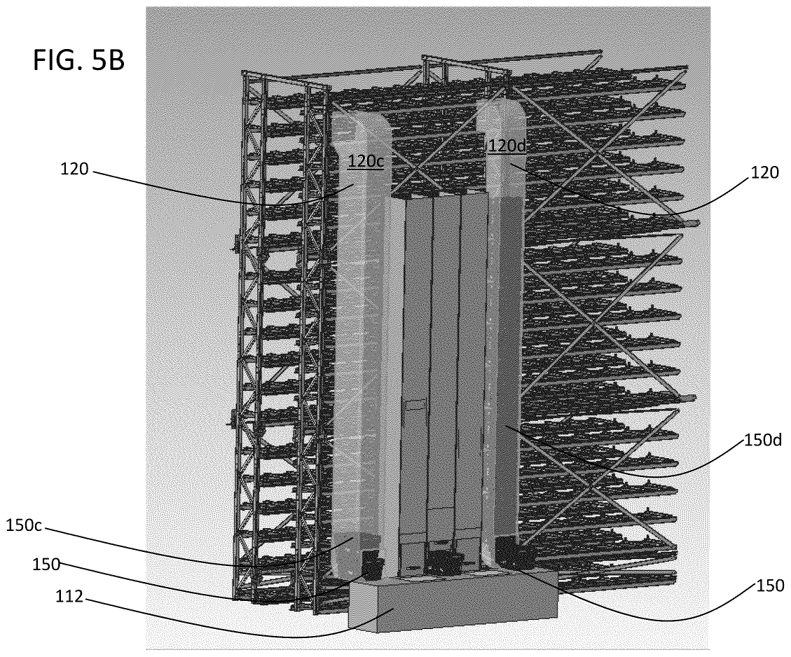

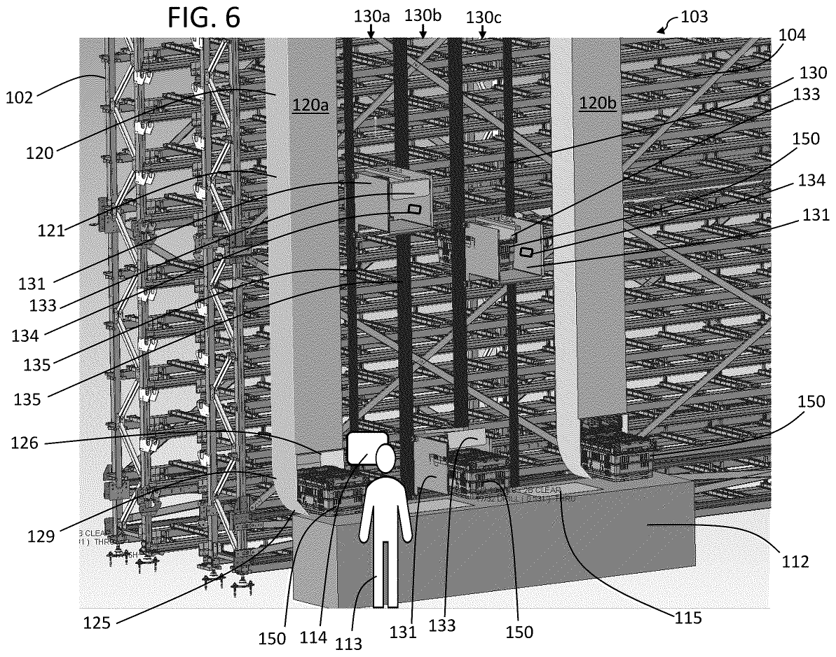

The system 103 further includes at least one chute 120 coupled to the storage structure 102, as shown in FIGS. 5A-7. The chute 120 provides separation between the operator 113 (e.g., a worker) at the workstation 112 and the mobile robots 160. In other words, the operator 113 does not directly interact with the mobile robots 160. Instead, mobile robots 160 deliver containers 150 to the chute 120, the containers 150 travel down the chute 120, and the operator 113 pulls containers 150 from the chute 120 at the workstation 112. While FIGS. 5A-6 show two chutes 120 (120a-b and 120b-c), any number of chutes 120 are contemplated. In embodiments where the system includes multiple chutes 120, the chutes 120 may be physically and/or functionally separate from one another. Additionally, while chutes 120a and 120b are shown in FIGS. 5A and 6 with similar dimensions and configurations, multiple chutes 120 with different dimensions and configurations may be used. For example, as shown in FIG. 5B, chutes 120c and 120d have different dimensions and configurations from another. In FIG. 5B, chute 120d is configured to accept containers 150 in an upright configuration, to rotate, or allow rotation of, the container 150 through the chute 120d, and to exit the container 150 from the chute 120d at the workstation 112 in an upright configuration. By contrast, chute 120c is configured to accept containers 150 in an upright configuration and to guide, move, or otherwise allow the containers 150 to remain substantially upright as they travel down the chute 120c to the workstation 112. In this configuration of the chute 120c, the container 150 may not rotate in the chute 120c, such that any products in the container 150 may remain in the container throughout the container's journey through the chute 120c to the workstation 112. Other configurations of chute 120 are also contemplated.

As shown in FIGS. 5A-7, each chute 120 extends vertically, e.g., along the storage structure 102, connecting the storage structure 102 with the workstation 112. The chute 120 has an originating end 122 with an upper opening 123 disposed at a particular level of the storage structure 102 and a terminal end 125 with a lower opening 126 disposed at the workstation 112. The originating end 122 and the terminal end 125 are connected by an elongated portion 121. The chute 120 may be of any shape and material suitable to receive containers 150 through the upper opening 123 at the originating end 122 of the chute and to guide, transport, or otherwise allow movement of the containers 150 through the elongated portion 121 of the chute and through the lower opening 126 at the terminal end 125 of the chute. In some aspects, containers 150 may be provided by mobile robots 160 through the upper opening 123 at the originating end 122 of the chute.

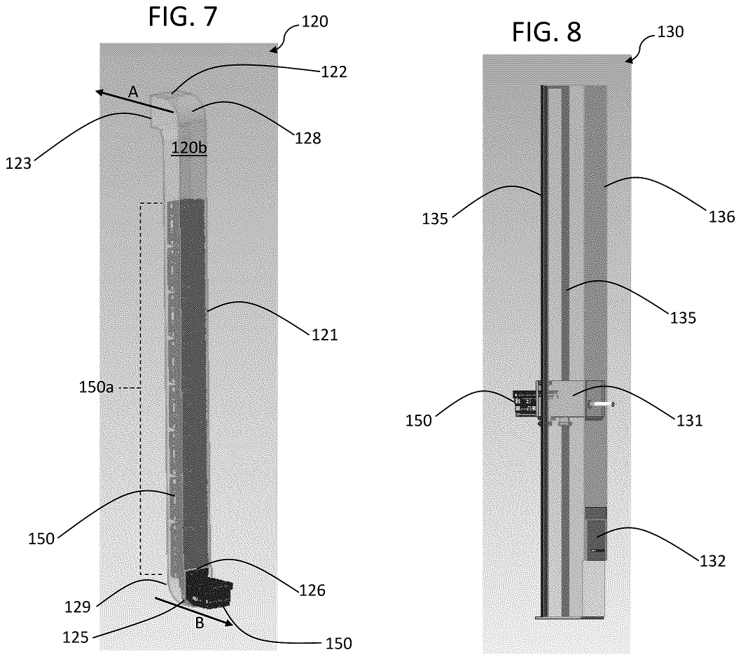

In some aspects, as shown in FIG. 7, the originating end 122 of the chute 120 may extend in a first direction A, and the terminal end 125 of the chute 120 may extend in a second direction B opposite the first direction A. The first and second directions may generally be perpendicular to the elongated portion 121 of the chute. For example, the originating end 122 of the chute 120 may be disposed at an angle of about 90 degrees from the elongated portion 121 in the first direction A, forming a first elbow 128, and the terminal end 125 may be disposed at an angle of about 90 degrees from the elongated portion 121 in the second direction B opposite the first direction, forming a second elbow 129.

The originating end 122 of the chute 120, and the upper opening 123 therein, and the terminal end 125 of the chute 120, and the lower opening 126, are sized to receive and exit containers 150 in their upright configuration. For example, the height of the originating end 122 and a height of the terminal end 125 may be larger than a height H of the container 150 such that the container 150 can enter the originating end 122 via the upper opening 123 in the container's upright configuration and exit the terminal end 125 via the lower opening 126 in the same upright configuration.

In some approaches, the originating end 122 and the upper opening 123 therein may be sized to receive containers 150 in one orientation but not another. For example, the originating end 122 and the upper opening 123 therein may be sized to receive containers 150 via the container's side end 155 or 156 but not via the container's lateral sides 153 and 154. In other approaches, the originating end 122 and the upper opening 123 therein may be sized to receive containers 150 via the container's lateral side 153 or 154 but not via the container's side ends 155 and 156. In some aspects, the terminal end 125 and the lower opening 126 may have similar dimensions as the originating end 122 and upper opening 123, respectively. In some aspects, the terminal end 125 and the lower opening 126 therein may be configured to allow an operator 113 at the workstation 112 to pull containers 150 from the terminal end 125 of the chute.

In some approaches, first elbow 128 of the chute 120 (e.g., chute 120b) may be configured to guide or otherwise allow the container 150 to rotate from an upright configuration to a side configuration. The elongated portion 121 of the chute 120 may be configured to guide or otherwise allow downward movement of the container 150 in this side configuration through the elongated portion 121 of the chute 120 in the direction of the workstation 112. The second elbow 129 of the chute 120 may be configured to guide or otherwise allow the container 150 to rotate from its side configuration back to its original upright configuration.

For example, an upright container 150 may be inserted into the upper opening 123 of the originating end 122 widthwise, such that a lateral side 153 of the container 150 is inserted into the upper opening 123 first. For example, a mobile robot 160 carrying the container 150 may drive the container 150 through the upper opening 123 of the originating end 122 of the chute 120. The shape and configuration of the first elbow 128 may guide or allow the container 150 rotate about 90 degrees so that the lateral side 153 faces downward toward the workstation 112. The container 150 then travels downward toward the workstation 112 though the elongated portion 121 of the chute 120 until the container 150 reaches the second elbow 129. The shape and configuration of the second elbow 129 may guide or otherwise allow the container 150 to rotate back about 90 degrees so that container 150 is back in its original upright configuration. The container 150 may then exit the terminal end 125 of the chute 120 such that the lateral side 153 of the container 150 exits the lower opening 126 of the terminal end 125 first. In some aspects, the container 150 may be pulled out of the lower opening 126 of the terminal end 125 of the chute 120 by the operator 113 at the workstation 112.

In some aspects, the chute 120 may be configured to house multiple containers 150, as shown in FIGS. 5A-7. As containers 150 are inserted into the chute 120 and travel down the elongated portion 121 towards the workstation 112, the containers 150 may form a stack in the chute 120 (see stack 150a in FIG. 7 and stacks 150c-d in FIG. 5A). For example, multiple containers 150 may be stacked or nested in the chute 120. When an operator 113 pulls a container 150 from the terminal end 125 of the chute 120, the containers 150 in the stack 150a may advance down the chute 120 and the next container 150 in the stack becomes available at the terminal end 125 for the operator 113 to pull. Having multiple containers 150 stacked in the chute 120 allows an operator 113 to have a supply of containers 150 from which to pull when decanting products into containers 150 at the workstation 112, reducing downtime and improving efficiency.

In some aspects, the chute may be passive, such that the containers 150 move through the elongated portion 121 of the chute 120 without mechanical assistance (e.g., under gravity). In such a configuration, it is preferable that the containers 150 are empty (i.e., do not contain any products). In other aspects, the chute 120 may include one or more mechanical components to guide or actively move containers 150 through the chute 120 or portions thereof. In such a configuration, the containers 150 may be empty or may contain at least one product.

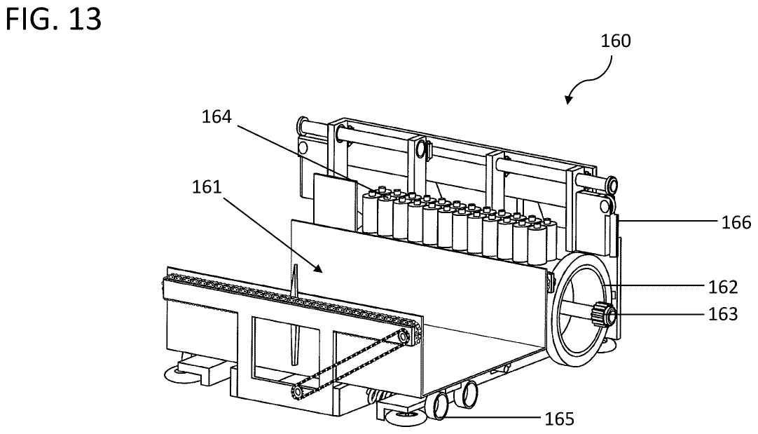

An example mobile robot 160 is shown in FIG. 13. The mobile robot 160 may include an item/container carrying portion 161, front drive wheels 162, vertical climbing gear 163, power storage 164, rear trailer wheels 165, and charging contacts 166. In some aspects, one or more sensors may be coupled to any portion of the mobile robot 160. For example, optical sensors may be coupled to the front, sides, and/or back of the mobile robot 160. In some aspects, the sensors may be configured to sense features via measuring vibration, acceleration, speed, etc. via one or more of the drive wheels 162, the trailer wheels 165, and the vertical climbing gear 163. In some embodiments, the sensors may be configured to detect the presence of charging rails or pads via the charging contacts 166. The mobile robot 160 is configured to traverse the storage structure and to carry and transport containers 150. For example, the mobile robots 160 may deliver empty or partially full containers 150 to chutes 120 associated with the storage structure 102 to replenish the supply of containers 150 used by the operator 113 at the workstation 112. The mobile robots 160 may also pick up containers 150 from the carriage 131 of the elevator 130 and transport the containers 150 to their assigned storage locations 104 in the storage structure 102.

In some aspects, the mobile robots 160 may drive or otherwise transfer containers 150 into the upper opening 123 of the originating end 122 of the chute 120. Any suitable device or component may be used to transfer containers 150 from the mobile robots 160 to the chute 120. Examples of container transfer systems, such as may be used in conjunction with this disclosure, are disclosed, for example, in U.S. Pat. No. 10,435,241, issued on Oct. 8, 2019, entitled “Storage and Retrieval System” and International Application No. PCT/US 2024/057678, filed on Nov. 11, 2024, entitled “Mobile Robot with Container Transfer”, all of which are incorporated by reference herein in their entirety.

The system 103 further includes at least one elevator 130 coupled to the storage structure 102, as shown in FIGS. 5A-6 and 8. The elevator 130 provides separation between the operator 113 (e.g., a worker) at the workstation 112 and the mobile robots 160. In other words, the operator 113 does not directly interact with the mobile robots 160. Instead, the operator 113 places a container 150 in the elevator 130 and the elevator 130 ejects or otherwise transfers the container 150 to a mobile robot 160 or to a position in the storage structure 102. While FIGS. 5A-6 show three elevators 130 (131a-c), any number of elevators 130 are contemplated. In embodiments where the system 103 includes multiple elevators 130, the elevators 120 may be physically and/or functionally separate from one another.

As shown in FIGS. 5A-7 and 8, the elevator 130 may include a carriage 131 movable along a shaft 135 that extends vertically from the workstation 112 along the storage structure 102 and terminates at a storage level of the storage structure 102. The elevator 130 may be surrounded by a housing 136. In some aspects, the elevator 130 may be configured to move the carriage 131 along the shaft 135 to the highest storage level of the storage structure 102. In other aspects, the elevator 130 may be configured to move the carriage 131 along the shaft 135 to a storage level that is partway up the storage structure 102. In embodiments with multiple elevators 130, one or more elevators may be configured to move the carriage 131 to the highest storage level of the storage structure 102 and/or to a storage level partway up the storage structure 102. Similarly, in a scenario where a container 150 transported by a carriage 131 may not be accessible by a mobile robot 160 at a particular storage level, for example, due to an obstruction, maintenance, or the like, which may impede the transfer of the container 150 from the carriage 131 to the mobile robot 160, one of the other elevators 130 may transport the container 150 to that particular storage level.

The carriage 131 is configured to accept a container 150 at the workstation 112 and to move the container 150 to storage levels of the storage structure 102. In some aspects, the container 150 in the carriage 131 may contain one or more products. In other aspects, the container 150 in the carriage 131 may be empty. The container 150 may be loaded into the carriage 131 by an operator 113 at the workstation 112. For example, an operator may pull a container 150 from a chute 120, load the container 150 with one or more products, and slide or push the container 150 into the carriage 131. A non-limiting example of a container 150 partially slid into a carriage 131 is illustrated in FIG. 5A (see elevator 130b) and in FIG. 11.

The elevator 130 may include a reader 134 configured to read machine-readable codes 157 affixed to containers 150 loaded in the carriage 131. The reader 134 may be disposed at any suitable location on, in, or near the elevator 130 provided the reader 134 can read the machine-readable codes 157 affixed to the containers as the containers are inserted into the carriage. In some aspects, as shown in FIGS. 5A-6 and 9-11, the reader 134 may be associated with the carriage 131. Non-limiting examples of suitable readers may include, but are not limited to, optical readers, radio frequency identification (RFID) readers, and the like.

The elevator 130 may further include an automatic door 132. The automatic door 132 may be configured to open when the carriage 131 arrives at the workstation 112 and to close after the container 150 is received by the carriage 131. For example, the control circuit 180 may receive a signal from the elevator 130 indicating that the carriage 131 has arrived at the workstation 112. As noted above, the elevator 130 is communicatively coupled to the control circuit 180 and may receive instructions from the control circuit 180. The control circuit 180 may instruct the automatic door 132 to open after receiving a signal from the elevator 130 and/or the workstation 112 indicating that the carriage 131 is located or “parked” at the workstation 112, so that the carriage 131 may receive a container 150 for transport. Once a container 150 has been loaded into the carriage 131 (e.g., by an operator 113 at the workstation 112), the reader 134 may read the machine-readable code 157 affixed to the container 150 and may send a signal to the control circuit 180 indicating that the container 150 has been loaded into the carriage 131. The signal sent by the reader 134 to the control circuit 180 may include an identifier identifying the particular container 150 loaded in the carriage 131. The control circuit 180 may send a signal or instruction to the elevator 130 causing the automatic door 132 to close and lock. In some approaches, the automatic door 132 may include an interlock mechanism, which prevents the carriage 131 from being elevated from the workstation 112 until or unless the automatic door 132 is closed.

The control circuit 180 may query one or more databases to obtain information about the container 150 in the carriage 131 and/or products contained therein. In some aspects, the control circuit 180 may query the storage database 172 that maps containers 150 to storage locations 104. The control circuit 180 may query the storage database 172 to determine an open storage location 104 in the storage structure 102 in which the container 150 may be stored. The control circuit 180 may assign the container 150 to the open storage location 104 and may update the storage database 172 to link the container 150 to the storage location 104.

The control circuit 180 may send an instruction or signal to the elevator 130 to cause the elevator 130 to transport the carriage 131 to the particular level associated with the open storage location 104 now assigned to the container 150. Once the carriage 131 has reached the particular level, the elevator 130 may eject the container 150. In some approaches, the control circuit 180 may send an instruction or signal to the elevator 130 to eject the container from the carriage 131. A non-limiting example of the elevator 130 ejecting a container 150 to a location in the storage structure 102 is shown in FIG. 6 (see 130c) and in FIG. 10.

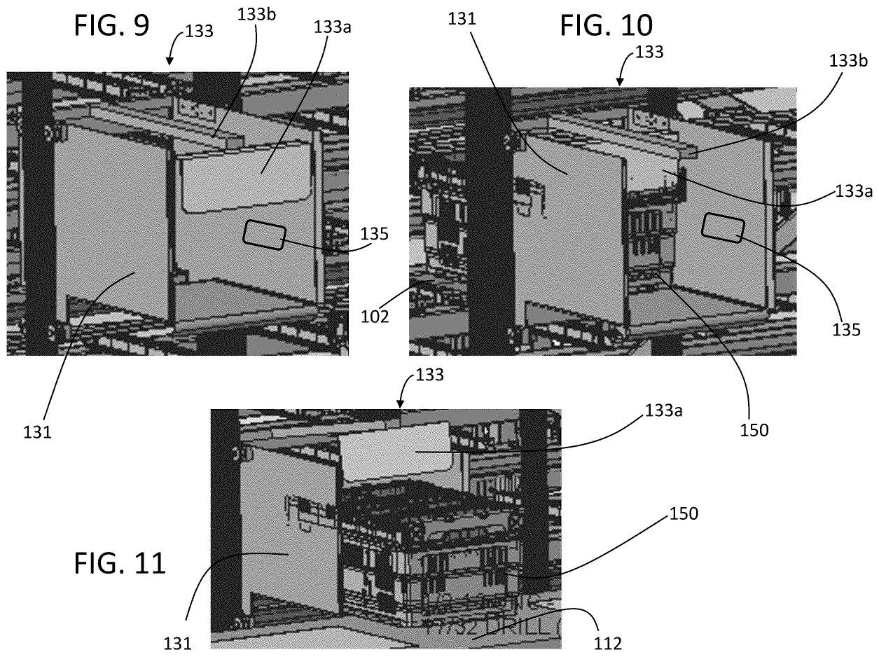

After the container has been ejected from the elevator, the control circuit 180 may send an instruction or signal to the elevator 130 to return to the workstation 112. A non-limiting example of the elevator 130 returning to the workstation 112 is shown in FIG. 6 (see elevator 130a) and in FIG. 9.

In some aspects, the elevator 130 may eject the container 150 to a mobile robot 160. The control circuit 180 may send a signal or instruction to a mobile robot 160 to retrieve the container 150 from the elevator 130 and to transport the container 150 to the open storage location 104 in the storage structure 102. Any suitable device or component may be used to transfer containers 150 from the elevator 130 to mobile robots 160 and from the mobile robots 160 to the storage locations 104. Examples of mobile robots having container transfer systems, such as may be used in conjunction with this disclosure, are disclosed, for example, in U.S. Pat. No. 10,435,241, issued on Oct. 8, 2019, entitled “Storage and Retrieval System” and International Application No. PCT/US 2024/057678, filed on Nov. 11, 2024, entitled “Mobile Robot with Container Transfer”, all of which are incorporated by reference herein in their entirety.

In some aspects, the elevator 130 may include an ejector 133 configured to eject the container 150 from the carriage 131. The control circuit 180 may send an instruction or signal to the elevator 130 to cause the ejector 133 to eject the container 150 from the carriage 131 to, for example, the storage structure 102 and/or a mobile robot 160. In some aspects, the control circuit 180 may send an instruction or signal to a mobile robot 160 to retrieve the ejected container 150 (e.g., directly from the carriage 131 or from a location in the storage structure 102 where the container 150 was ejected).

As shown in FIGS. 6 and 9-11, the ejector 133 may include a push mechanism 133a movable along a rail 133b that extends the length of the carriage 131. The rail 133b may be affixed to an upper portion of the carriage 131 and may be pivotable to allow a container 150 to enter the carriage 131 from the workstation 112. The push mechanism 133a is positioned behind the container 150 in the carriage 131 and is configured to move along the rail 133b to push or drive the container out of the carriage 131.

FIG. 9 shows a non-limiting example of the ejector 133 (including the push mechanism 133a and the rail 133b) in an initial position when the carriage 131 is not holding a container 150. In FIG. 9, and as shown in FIG. 6 (see elevator 130a), the carriage 131 has already dropped off a container 150 to the storage structure 102 and is returning to a “park” position at the workstation 112. In the ejector's initial position, the rail 133b is substantially parallel to the bottom surface of the carriage 131 and the push mechanism 133a is positioned at the workstation 112 side of the carriage 131 (i.e., at the side of the carriage facing the workstation 112).

FIG. 11 shows a non-limiting example of the carriage 131 in the park position at the workstation 112. In the park position, the push mechanism 133a of the ejector 133 may be raised by the pivotable rail 133b to allow a container 150 to pass under the push mechanism 133a when the container 150 enters the carriage 131 from the workstation 112. With the container 150 in the carriage 131, the rail 133b may then return the push mechanism 133a to its initial position, where the push mechanism 133a is located behind the container 150 in the carriage 131.

FIG. 10 shows a non-limiting example of the ejector 133 ejecting the container 150 to the storage structure 102. To eject the container 150 from the carriage 131, the push mechanism 133a moves along the rail 133b to push or drive the container 150 out of the carriage 131 and into a position in the storage structure 102. Once the push is complete, the push mechanism 133a moves along the rail 133b away from the container 150 and back to its initial position, as shown in FIG. 9, and the carriage 131 returns to its park position at the workstation 112, where it may accept another container 150.

The following is a non-limiting example of an implementation of the system 103 in a fulfillment facility 100 that utilizes an automated storage and retrieval system (ASRS). A worker (e.g., an operator 113) at the workstation 112 pulls a container 150 from the terminal end 125 of the chute 120 and slides it onto a surface of the workstation 112. The surface of the workstation may include a sensor 115 to weigh the container 150. The worker places products to be decanted in the container 150 and the sensor 115 weighs to container 150 to ensure its weight does not exceed a predetermined limit. The worker slides the container 150 into a carriage 131 of the elevator 130 parked at the workstation 112 (the automatic door 132 of the elevator 130 is open when the carriage 131 is empty and in the park position). As the container 150 is slid into the carriage 131, the reader 134 reads a machine-readable code 157 on the container 150 and sends an identification of the container 150 to the control circuit 180. Receipt of the container's identification by the control circuit 180 triggers the control circuit 180 to close and lock the automatic door 132 of the elevator 130. The control circuit 180 queries the storage database 172 to determine an open position in which to store the container 150 in the storage structure 102. The control circuit 180 assigns the container 150 to that storage location 104 and updates the storage database 172 to include the storage location 104 of the container 150. The control circuit 180 sends an instruction to the elevator 130 to transport the carriage 131 with the container 150 to the assigned level of the storage structure 102. The control circuit 180 also dispatches a mobile robot 160 to meet the container 150 at the elevator 130 on the assigned level and to transport the container 150 to the assigned storage location 104. Once the carriage 131 arrives at the assigned level, the ejector 133 ejects the container 150 to the mobile robot 160 and the mobile robot 160 transports the container 150 to the assigned storage location 104. The carriage 131 returns to its park location at the workstation 112 to accept another container 150. Additionally, various mobile robots 160 are dispatched to collect empty or partially full containers 150 and deliver them to the chute 120 so that there is a supply of containers 150 in the chute 120 from which the worker can pull when decanting products into containers 150 at the workstation 112.

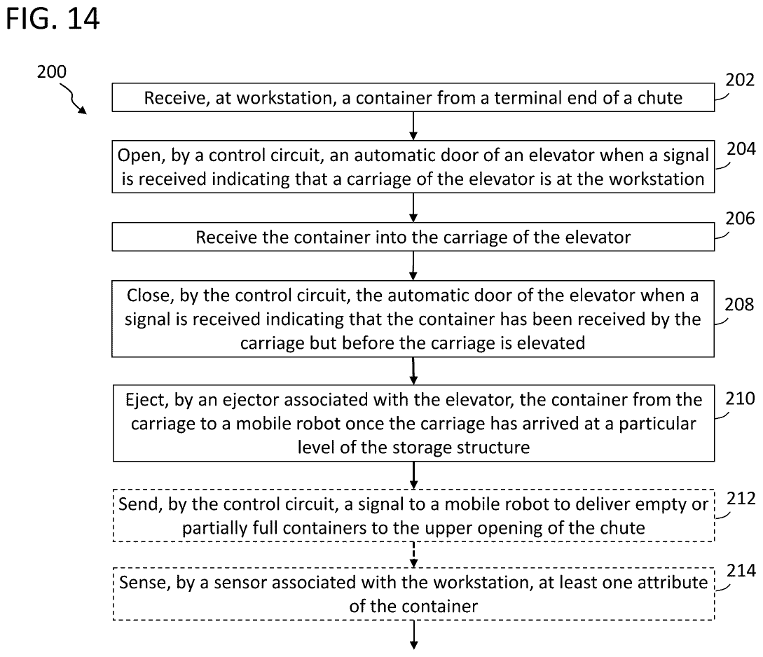

FIG. 14 shows a method 200 of transferring containers to a storage structure. The method 200 may use some or all of the components described above, such as, for example, components of the system 103 for transferring containers to a storage structure described above. The method 200 may be implemented as part of an automated storage and retrieval system, for example, in a fulfillment facility (e.g. fulfillment facility 100).

At block 202, in some aspects, a container (e.g., container 150) is received at a workstation (e.g., workstation 112) from a chute (e.g., chute 120). The container may be received from the chute by an operator (e.g., operator 113) at the workstation. In some aspects, the operator may be a human operator. In some aspects, the operator may be a robotic operator. The container generally has room for at least one product. Thus, the container may be empty or partially full when received at the workstation from the chute. The chute extends vertically along a storage structure (e.g., storage structure 102), which comprises multiple vertically spaced levels that each comprise multiple aisles having storage locations (e.g., storage locations 104). The chute has an originating end disposed at a level of the storage structure and the terminal end disposed at the workstation. The chute may receive containers provided by mobile robots through an upper opening at the originating end of the chute, and may guide the containers to a lower opening at the terminal end of the chute. In some aspects, the chute may hold multiple containers stacked or housed at the terminal end of the chute, which may provide the operator with a supply of containers from which to pull at the workstation. The operator may load a product into the container at the workstation.

At block 204, in some aspects, a control circuit (e.g., control circuit 180) may receive a signal from an elevator (e.g., elevator 130) and/or the workstation indicating that the elevator's carriage has arrived or is parked at the workstation. The elevator may include the carriage (e.g., carriage 131), an automatic door (e.g., automatic door 132), a reader (e.g., reader 134), and an ejector (e.g., ejector 133), and is configured to vertically transport containers via the carriage from the workstation to levels of a storage structure and to return the carriage to the workstation. The control circuit, executing a set of computer executable instructions, may cause the automatic door to open after receiving the signal indicating that the carriage is parked at the workstation.

At block 206, in some aspects, a container is received into the carriage of the elevator. In some aspects, the operator may slide the container into the carriage. The container may be empty or partially full when it is received into the carriage.

At block 208, in some aspects, the control circuit may cause the automatic door of the elevator to close when a signal is received indicating that the container has been received by the carriage. For example, the control circuit may receive a signal from the reader, or any other sensor, indicating that the container is present in the carriage. The control circuit may then send a signal or instruction to the automatic door, causing the automatic door to close.

At block 210, in some aspects, the ejector associated with the elevator may eject the container from the carriage (e.g., to a mobile robot) once the carriage has arrived at a particular level of the storage structure. For example, the control circuit may send a signal or instruction to the ejector to eject the container from the carriage upon receiving a signal that the carriage has arrived at the particular level of the storage structure.

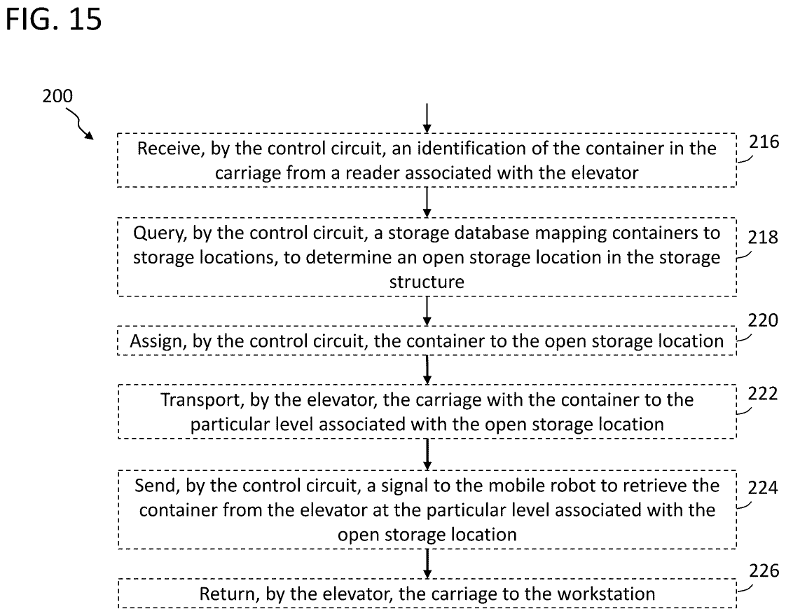

The method 200 may further include any of the optional steps 212-226 described below with reference to FIGS. 14-15.

At block 212, in some aspects, the control circuit may send a signal or instruction to one or more mobile robots to deliver empty or partially full containers to the upper opening of the chute. In this way, a supply of containers may be stacked or otherwise housed in the chute for the operator to use at the workstation. The mobile robots may retrieve or collect containers from any suitable location in the storage structure and/or the fulfillment facility.

At block 214, in some aspects, a sensor associated with the workstation may sense at least one attribute of the container. The control circuit may receive and process data from the sensor. For example, the carriage may have a weight limit, and a weight sensor associated with the workstation may alert the operator if the container exceeds the carriage's weight limit. Suitable sensors may include, but are not limited to, optical sensors, imaging sensors, radio frequency identification (RFID) sensors/readers, temperature sensors, infrared sensors, humidity sensors, sound sensors, weight sensors, and/or proximity sensors.

At block 216, in some aspects, the control circuit may receive an identification of the container in the carriage from a reader associated with the elevator. For example, the reader may be associated with the carriage. The reader is configured to read machine-readable codes affixed to the containers, the machine-readable codes encoding at least an identification of the container. Suitable readers may include, but are not limited to, optical readers, radio frequency identification (RFID) readers, and the like.

At block 218, in some aspects, the control circuit may query a storage database mapping containers to storage locations to determine an open storage location in the storage structure.

At block 220, in some aspects, the control circuit may assign the container to the open storage location. For example, the control circuit may update the storage database to link the container to the storage location.

At block 222, in some aspects, the elevator may transport the carriage with the container to the particular level associated with the open storage location. For example, the control circuit may send a signal or instruction to the elevator to transport the carriage to the level of the storage structure having the open storage location.

At block 224, in some aspects, the control circuit may send a signal to a mobile robot to retrieve the container from the elevator at the particular level associated with the open storage location. The control circuit may also instruct the mobile robot to transport the container to the open storage location.

At block 226, in some aspects, the elevator may return the carriage to the workstation. For example, the control circuit may send a signal or instruction to the elevator to return the carriage to the park position at the workstation to that the carriage is available to receive another container.

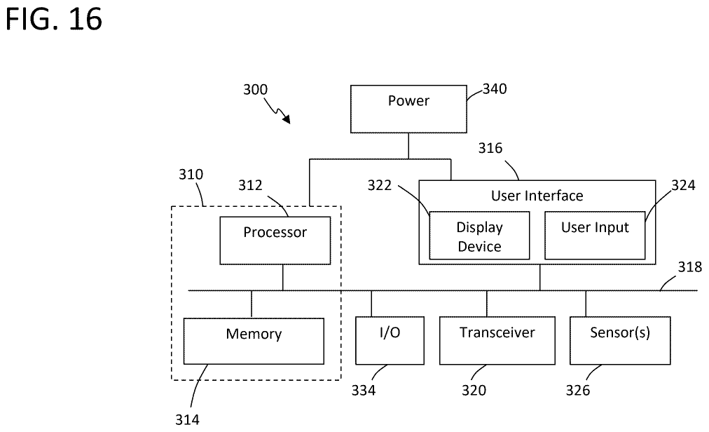

The circuits, circuitry, systems, devices, processes, methods, techniques, functionality, services, servers, sources, and the like described herein may be utilized, implemented and/or run on many different types of devices and/or systems. FIG. 16 illustrates an example system 300 that may be used for implementing the method illustrated in FIGS. 14-15 as well as any of the components, devices, circuits, circuitry, systems, functionality, apparatuses, processes, or devices described herein. However, the use of the system 300 or any portion thereof is certainly not required.

By way of example, the system 300 may comprise one or more control circuits or processors 312, memory 314, and one or more communication links, paths, buses 318 or the like. Some embodiments may include one or more user interfaces 316, and/or one or more internal and/or external power sources or supplies 340. The processor 312 (which may form all or part of control circuit 180) can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 312 can be part of control circuitry and/or a control system 310, which may be implemented through one or more processors with access to one or more memory 314 that can store instructions, code and the like that is implemented by the control circuit and/or processors to implement intended functionality, processing modules, and the like. In some applications, the control circuit and/or memory may be distributed over a communications network (e.g., LAN, WAN, Internet) providing distributed and/or redundant processing and functionality. Again, the system 300 may be used to implement one or more of the above or below, or parts of, components, circuits, systems, processes and the like.

The user interface 316 can allow a user to interact with the system 300 and receive information through the system. In some instances, the user interface 316 includes a display 322 and/or one or more user inputs 324, such as buttons, touch screen, track ball, keyboard, mouse, etc., which can be part of or wired or wirelessly coupled with the system 300. Typically, the system 300 further includes one or more communication interfaces, ports, transceivers 320 and the like allowing the system 300 to communicate over a communication bus, a distributed computer and/or communication network 318 (e.g., a local area network (LAN), the Internet, wide area network (WAN), etc.), communication link 318, other networks or communication channels with other devices and/or other such communications or combination of two or more of such communication methods. Further the transceiver 320 can be configured for wired, wireless, optical, fiber optical cable, satellite, or other such communication configurations or combinations of two or more of such communications. Some embodiments include one or more input/output (I/O) ports 334 that allow one or more devices to couple with the system 300. The I/O ports can be substantially any relevant port or combinations of ports, such as but not limited to USB, Ethernet, or other such ports. The I/O interface 334 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 326 to provide information to the system and/or sensor information that is communicated to another component, such as the control circuit 312 and one or more databases. The sensors can include substantially any relevant sensor, such as distance measurement sensors (e.g., optical units, sound/ultrasound units, etc.), optical-based scanning sensors to sense and read optical patterns (e.g., bar codes, QR codes, etc.), imaging sensors, thermal sensors, cameras, RFID reader, other such sensors or a combination of two or more of such sensor systems. The foregoing examples are intended to be illustrative and are not intended to convey an exhaustive listing of all possible sensors. Instead, it will be understood that these teachings will accommodate sensing any of a wide variety of circumstances in a given application setting.

The system 300 comprises an example of a control and/or processor-based system with the control circuit 312. Again, the control circuit 312 can be implemented through one or more processors, controllers, central processing units, logic, software and the like. Further, in some implementations the control circuit 312 may provide multiprocessor functionality.

The memory 314, which can be accessed by the control circuit 312, typically includes one or more processor readable and/or computer readable media accessed by at least the control circuit 312, and can include volatile and/or nonvolatile media, such as RAM, ROM, EEPROM, flash memory and/or other memory technology. Further, the memory 314 is shown as internal to the control system 310; however, the memory 314 can be internal, external or a combination of internal and external memory. Similarly, some or all of the memory 314 can be internal, external or a combination of internal and external memory of the control circuit 312. The external memory can be substantially any relevant memory such as, but not limited to, solid-state storage devices (SSDs) or drives, hard disk drive (HDDs), one or more of universal serial bus (USB) stick or drive, flash memory secure digital (SD) card, other memory cards, and other such memory or combinations of two or more of such memory, and some or all of the memory may be distributed at multiple locations over a computer network. The memory 314 can store code, software, executables, scripts, data, content, lists, programming, programs, log or history data, user information, coupon information, manufacturer information, customer information, product information, and the like. While FIG. 12 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system for transferring containers to a storage structure, comprising:
a workstation cooperated with a storage structure, the storage structure comprising multiple vertically spaced levels that each have multiple storage locations;
a chute extending vertically along the storage structure, the chute having an originating end disposed at a level of the storage structure and a terminal end disposed at the workstation, wherein the chute is to receive containers provided by mobile robots through an upper opening at the originating end of the chute and to guide the containers to a lower opening at the terminal end of the chute, and the chute is to hold multiple containers stacked at the terminal end; and
an elevator to vertically transport containers via a carriage from the workstation to levels of the storage structure and to return the carriage to the workstation, the elevator comprising:
the carriage for receiving a container;
an automatic door to open when the carriage arrives at the workstation and to close after the container is received by the carriage; and
an ejector to eject the container from the carriage to a mobile robot once the carriage has arrived at a particular level of the storage structure.

2. The system of claim 1, further comprising:
a reader associated with the elevator to read identifiers affixed to containers;
a computer-readable storage memory storing a storage database mapping containers to storage locations, and a set of computer executable instructions; and
a control circuit communicatively coupled to the workstation, elevator, and mobile robots, the control circuit to execute the set of computer executable instructions, which causes the control circuit to:
receive from the reader an identification of the container in the carriage;
query the storage database to determine an open storage location in the storage structure;
assign the container to the open storage location;
cause the elevator to transport the carriage with the container to the particular level associated with the open storage location;
send signal to the mobile robot to retrieve the container from the elevator at the particular level associated with the open storage location; and
cause the elevator to return the carriage to the workstation.

3. The system of claim 1, further comprising a control circuit communicatively coupled to the mobile robots and to execute a set of computer executable instructions, which causes the control circuit to send a signal to a mobile robot to deliver empty or partially full containers to the upper opening of the chute.

4. The system of claim 1, wherein the workstation comprises a sensor for sensing at least one attribute of the container.

5. The system of claim 1, comprising a plurality of the chutes and a plurality of elevators, wherein the plurality of the chutes function separately from one another and the plurality of the elevators function separately from one another.

6. The system of claim 1, wherein the workstation is inaccessible by the mobile robot from the storage structure.

7. The system of claim 1, wherein the containers delivered to the chute by the mobile robot are empty, and the chute is passive such that the empty containers travel down the chute without mechanical assistance.

8. The system of claim 1, wherein the chute comprises an elongated portion connecting the originating end and the terminal end, the originating end is disposed at an angle of about 90 degrees from the elongated portion in a first direction, and the terminal end is disposed at an angle of about 90 degrees from the elongated portion in a second direction opposite the first direction.

9. The system of claim 8, wherein a height of the originating end of the chute and a height of the terminal end of the chute are larger than a height of the container such that the container can enter the originating end via the upper opening in an upright configuration and exit the terminal end via the lower opening in the upright configuration.

10. The system of claim 9, wherein:
an interface of the originating end and the elongated portion forms a first elbow in which the container is rotated from the upright configuration to a second configuration where a side of the container is facing downward in the direction of travel; and
an interface of the elongated portion and the terminal end forms a second elbow in which the container is rotated from the second configuration back to the upright configuration.

11. A method for transferring containers to a storage structure, comprising:
receiving, at a workstation, a container from a terminal end of a chute, wherein the chute extends vertically along a storage structure, the storage structure comprising multiple vertically spaced levels that each comprise multiple aisles having storage locations, and the chute having an originating end disposed at a level of the storage structure and the terminal end disposed at the workstation, wherein the chute is to receive containers provided by mobile robots through an upper opening at the originating end of the chute and to guide the containers to a lower opening at the terminal end of the chute, and the chute is to hold multiple containers stacked at the terminal end;
opening, caused by a control circuit to execute a set of computer executable instructions, an automatic door of an elevator when a signal is received indicating that a carriage of the elevator is at the workstation, wherein the elevator is to vertically transport containers via the carriage from the workstation to levels of a storage structure and to return the carriage to the workstation;
receiving the container into the carriage of the elevator;
closing, caused by the control circuit, the automatic door of the elevator when a signal is received indicating that the container has been received by the carriage; and
ejecting, by an ejector associated with the elevator, the container from the carriage to a mobile robot once the carriage has arrived at a particular level of the storage structure.

12. The method of claim 11, further comprising:
receiving, by the control circuit, an identification of the container in the carriage from a reader associated with the elevator and to read identifiers affixed to containers;
querying, by the control circuit, a storage database mapping containers to storage locations, to determine an open storage location in the storage structure;
assigning, by the control circuit, the container to the open storage location;
transporting, by the elevator, the carriage with the container to the particular level associated with the open storage location;
sending, by the control circuit, a signal to the mobile robot to retrieve the container from the elevator at the particular level associated with the open storage location; and
returning, by the elevator, the carriage to the workstation.

13. The method of claim 11, further comprising, by the control circuit, sending a signal to a mobile robot to deliver empty or partially full containers to the upper opening of the chute.

14. The method of claim 11, further comprising, by a sensor associated with the workstation, sensing at least one attribute of the container.

15. The method of claim 11, wherein the chute and the elevator function separately from one another.

16. The method of claim 11, wherein the workstation is inaccessible by the mobile robot from the storage structure.

17. The method of claim 11, wherein the containers delivered to the chute by the mobile robot are empty, and the chute is passive such that the empty containers travel down the chute without mechanical assistance.

18. The method of claim 11, wherein the chute comprises an elongated portion connecting the originating end and the terminal end, the originating end is disposed at an angle of about 90 degrees from the elongated portion in a first direction, and the terminal end is disposed at an angle of about 90 degrees from the elongated portion in a second direction opposite the first direction.

19. The method of claim 18, wherein a height of the originating end of the chute and a height of the terminal end of the chute are larger than a height of the container such that the container can enter the originating end via the upper opening in an upright configuration and exit the terminal end via the lower opening in the upright configuration.

20. The method of claim 19, wherein:
an interface of the originating end and the elongated portion forms a first elbow in which the container is rotated from the upright configuration to a second configuration where a side of the container is facing downward in the direction of travel; and
an interface of the elongated portion and the terminal end forms a second elbow in which the container is rotated from the second configuration back to the upright configuration.
